(19) United States
(12) Patent Application Publication
(10) Pub. No.: US 2010/0162473 A1
(43) Pub. Date: Jul. 1, 2010

(54) WATER-PERMEABLE PROTECTIVE MATERIAL

(76) Inventors: Colin Robert Willis, Wiltshire (GB); Stuart Anson Brewer, Wiltshire (GB); Michael Robert Dennis, Wiltshire (GB); Corrine Amy Stone, Wiltshire (GB)

Correspondence Address: JOHN S. PRATT, ESQ;KILPATRICK STOCKTON, LLP, 1100 PEACHTREE STREET, SUITE 2800, ATLANTA, GA, 30309, US

(21) Appl. No.: 12/531,705

(22) PCT Filed: Mar. 17, 2008
(86) PCT No.: PCT/GB2008/000939

§ 371 Date: Feb. 25, 2010

(30) Foreign Application Priority Data
Mar. 17, 2007 (GB) 0705170.9

(51) Int. Cl. A62B 17/00; B32B 5/00; B32B 5/24; B32B 3/26; B05D 1/30; B32B 37/14; B29C 39/00; B29C 45/00; B29C 47/00; C08L 29/04; C08K 5/17

(52) U.S. Cl. 2/455; 428/220; 442/76; 428/304.4; 428/315.5; 427/420; 156/242; 264/299; 264/328.1; 264/176.1; 525/56; 525/57; 524/236; 524/503

(57) ABSTRACT

A water-permeable protective material is provided which comprises a composition of one or more quaternary amines in combination with polyvinyl alcohol or precursor thereof. The amine may be either a polymeric or non-polymeric quaternary amine, a preferred example being poly(diallyldimethylammonium chloride) [p(DADMAC)]. The composition, if liquid, may be deposited as a layer on a substrate to be protected or a protective article may be formed by extrusion or moulding from a dry composition. The substrate may be a fabric material, particularly an item of clothing. Protection is provided against harmful or noxious agents such as chemical and biological warfare agents, organic materials, aerosols and other harmful liquid and gaseous substances.

The present invention relates to a water-permeable protective material which comprises a composition of a quaternary amine, particularly a polymeric quaternary amine, and polyvinyl alcohol. By “protective material” is meant a material which provides a barrier to passage of unwanted substances such as toxic or hazardous substances.

Protective fabrics and clothing are widely used by emergency services and armed forces world-wide to provide protection against harmful materials. The harmful agents are typically organic compounds and may vary from bulk chemicals held in large containers to chemical or biological warfare agents.

Such protective fabric and clothing is broadly of three types, impermeable, air permeable and water vapour permeable. Impermeable protective clothing is typically rather heavy and bulky, being generally made of a variety of rubber or neoprene. Although it provides very good protection, its lack of air and water vapour permeability means that the wearer can suffer severe physical stress particularly when required to be physically active. These materials also tend to be inflexible and hence inconvenient for wearing when freedom of movement is important. Consequently, a considerable amount of effort has been invested into replacing these types of material with alternative types of protective material which exhibit at least some degree of either water vapour permeability or air permeability.

Air permeable protective clothing has high water vapour permeability but the nature of its air permeability means that protection from some substances can be low. On the other hand, water vapour permeable protective clothing falls, in its performance as a protective material, somewhere between the impermeable materials and the air permeable materials. Thus, it provides protection against most but not all agents whilst imposing a lower physical burden than does impermeable clothing. Most of the protective clothing which is currently used by armed forces is made of various types of air permeable textile with some form of carbon loaded onto it to act as an absorbent for noxious materials such as chemical and biological warfare agents.

Applicant's earlier co-pending patent application (WO 03/062321) discloses and claims the use of a polymer composition comprising polyethylenimine (PEI) and one or both of polyvinyl alcohol and polyvinyl alcohol co-ethylene for protection against harmful and/or noxious agents. Such compositions exhibit substantial water permeability while at the same time providing a better level of protection than is provided by conventional water permeable materials.

It has now surprisingly been found that protective materials comprised of polymer compositions of quaternary amines in combination with polyvinyl alcohol (PVOH) will overcome some or all of the problems evidenced in the earlier systems. In particular such compositions can provide relatively lightweight and flexible protective materials which possess unexpectedly good barrier properties against harmful agents, such as gaseous and liquid chemical warfare agents, but which also demonstrate good water permeability properties and are therefore relatively comfortable for the wearer.

These polymeric quaternary amine—PVOH compositions also demonstrate advantages over PEI-PVOH compositions in that PEI reacts with carbon dioxide in the atmosphere whereas the polymeric amines do not or at least not to anything like the same extent.

It has been found that the water vapour permeability of such compositions is higher than with polyvinyl alcohol (PVOH) alone and that the protective materials according to this invention provide higher levels of protection against a number of the agents of interest. In particular materials according to the present invention may be used to provide protection against organic agents. Such protection is useful for those dealing with spills of organic agents, such as diesel and petrol. Protection may also be provided against harmful agents in the gaseous and/or liquid states and against aerosols. Protection is also preferably provided by the materials of the invention against chemical warfare agents and/or biological warfare agents.

In accordance with the present invention, a water vapour permeable protective material suitable for protection against harmful and/or noxious agents comprises a composition comprising a mixture of a quaternary amine and polyvinyl alcohol.

The quaternary amine may be either a polymeric or a non-polymeric quaternary amine. A preferred material comprises the polymeric quaternary amine poly(diallyldimethyl-ammonium chloride) [p(DADMAC)] but other such materials include a copolymer with acrylamide-poly(acrylamide-co-diallyldimethylammonium chloride), poly(acrylamide 2-methacryloxyethyltrimethylammonium bromide), poly[bis(2-chloroethyl)ether-alt-1,3-bis [3-(dimethylamino)propyl]urea], quaternised, poly(diallyldiethylammonium bromide) and poly(4-vinylpyridine), methyl chloride quaternised. Non-polymeric quaternary amines of interest include tetrabutylammonium chloride, tetrabutylammonium bromide, tetrabutylammonium iodide, tetrabutylammonium sulphate and tetraethylammonium chloride.

Polyvinyl alcohol (PVOH) is a versatile, water-soluble polymer that is used as an adhesion promoter and as an oxygen barrier in the packaging industry. As used in the protective materials of the present invention, the polyvinyl alcohol may be in any form, that is, having any degree of hydrolysis provided only that the composition made from it is able to form a film. As well as polyvinyl alcohol itself, other forms of polyvinyl alcohol that are suitable for use in the compositions of this invention include precursors of PVOH such as polyvinyl acetate, together with co-polymers of PVOH that are capable of forming films, for example polyvinyl alcohol co-ethylene and poly(vinyl alcohol-co-vinyl acetate-co-itaconic acid).

The total mass of the quaternary amine and polyvinyl alcohol in the protective materials of the invention may comprise between 10% and 95% and preferably between 60% and 95% of the mass of the polymer composition. Such polymer contents give good protection against harmful and/or noxious agents.

The balance of the polymer composition may comprise water. The use of water reduces stiffness and increases the flexibility of any material incorporating the polymer composition and is, furthermore, a cheap and non-toxic solvent with which to prepare the polymer composition. However, the use of non-aqueous solvents may be advantageous in some circumstances and for particular applications. For example, some forms of PVOH are not soluble in water alone but require the use of another solvent (eg isopropyl alcohol) as a co-solvent.

Alternatively the composition may be a dry or substantially dry composition in which case items embodying the composition that cannot readily be made from a liquid composition, such as respirators, can instead be obtained easily using forming processes such as moulding, extrusion or casting.

The protective material composition may further comprise a cross-linking agent which allows the solubility of the composition to be altered as seen fit by the person skilled in the art.

The protective material composition may further comprise a wetting agent, surfactant or other additive to allow a person skilled in the art to modify the properties of the material to suit the manufacturing requirements. For example, additives, including other polymers, might be used to increase the hydrophilicity of the blend or to reduce its flammability. As well as traditional fire retardants, the addition of hydrophilic polymers that form films with higher water contents such as agarose, chitosan, gelatin (which are gelling agents and form hydrogels that are mostly—eg up to and over 99%—water), may be used to reduce flammability and to maintain (or even increase) the water vapour permeability of the composition. Other additives for the same purpose include poly(vinyl sulphonic acid) or its salts and polyethylene glycols.

Metal salts to assist in the decomposition of chemical warfare agents may also be added to the protective material compositions of the invention. Such salts include polyoxometalates based on tungsten or molybdenum, metal oxides particularly in nanoparticle form, e.g. TiO₂, MgO, SiO₂, Al₂O₃, CaO, also chromates and salts of vanadium, copper and ruthenium. Materials suitable for rendering the compositions antimicrobial or to enhance an existing antimicrobial property may also be added to the compositions of the invention, examples of such including silver and copper salts, triclosan and N-chlorimides.

For use as a protective material, the composition is preferably in the form of a layer. This allows the composition to be readily applied to the surface of any object which it is desired to protect against harmful agents. Where the composition is used in the form of a layer, the layer may conveniently have a thickness of between 1 and 1000 μm. The required thickness will depend on the precise mode of use of the composition. For example, for application on to a fabric substrate, it has been found that it may be desirable for the layer thickness to be between 10 and 100 μm, preferably between 20 and 60 μm. This gives good protection, without making the fabric too heavy or stiff. For other applications it may be desirable for the layer to have a thickness of at least 20 μm. The coated fabric may be an item of clothing and will demonstrate permeability to water vapour but will have a low permeability to harmful agents.

According to a further aspect therefore the invention provides a fabric material coated with a layer of a composition of a quaternary amine such as poly(diallyldimethylammonium chloride) and polyvinyl alcohol. The fabric material may comprise an item of protective clothing.

As applied to surfaces (e.g. of a fabric material) in the form of a layer, the protective material composition preferably demonstrates a substantial permeability to water vapour, preferably of at least 400 g/m²/day, more preferably of at least 600 g/m²/day and most preferably of at least 800 g/m²/day.

According to a further aspect the invention provides a method of providing substantially water permeable protection against harmful agents, the method comprising applying a coating of a composition comprising a quaternary amine and polyvinyl alcohol to an object to be protected.

The quaternary amine component of the composition is preferably a polymeric quaternary amine and in particular poly (diallyldimethylammonium chloride) (p(DADMAC)) is a suitable material.

The object may comprise the surface of a fabric or other form of covering, as, for example, an extruded or thermoformed material or a tent or other temporary structure or the like.

Preferably the protective material composition is applied to the surface which it is desired to protect by the method of casting the composition directly onto the surface but other methods well known in the art of coating, such as painting or spraying the composition onto the surface, may be used instead, depending on the circumstances. For example, where the area to be covered is large or of an awkward shape such that it would be difficult or time consuming to cast the material onto the entire surface to be covered, the alternative methods of spraying or painting on the composition may be applicable. Alternatively, the composition could be cast onto a temporary substrate such as a sheet of glass from which it can be subsequently peeled off to provide a sheet of composition for subsequent application to the surface or the object to be protected. The skilled addressee will be fully aware of the various techniques that are available for applying coatings to surfaces any of which may be useful in the application of the present invention.

Where instead a dry or substantially dry composition is used, forming processes such as moulding, extrusion or casting may be used to obtain articles comprising the protective materials of the invention, e.g. parts for respirators.

The protective material composition of the present invention may be applied to the surface of an object to be protected in the form of a sacrificial coating. A sacrificial coating is one that may be readily removed from the surface on which the coating is formed. Alternatively, the sacrificial coating may be a coating wherein a portion of an exposed surface of the coating may be readily removed to yield more of the sacrificial coating beneath. In this way, a coating (or portion thereof) contaminated with a harmful agent may be readily removed if desired.

As an alternative to a sacrificial coating, a layer of the protective material composition may be covered with at least one layer of a material selected so as to provide protection for the composition layer. This may be useful, for example, where the composition is subject to attack e.g. by substances generally present in the atmosphere. In a further embodiment of the invention a layer of the water vapour permeable protective material is interposed between two or more other layers which are chosen so as to provide protection from degradation of the protective material. Such layers of externally protective material should comprise either a hydrophilic material or a microporous material so as to allow water vapour transfer to occur through the externally protective material. At the same time these outer layers would protect the PVOH-p(DADMAC) from being dissolved by liquid water.

In a further aspect of the invention therefore, there is provided a laminate suitable for providing protection against harmful and/or noxious agents, the laminate comprising at least one layer of a composition comprising a mixture of a quaternary amine and polyvinyl alcohol which is substantially permeable to water vapour. Preferably said layer or layers is provided in combination with one or more layers of a microporous or hydrophilic material and in particular a layer of the protective material may be placed between two or more other layers of a microporous or hydrophilic material.

The outer layers of the laminate material described could be comprised of the same or different materials and one of the layers may be a textile material. Conveniently, the protective material of the invention could be arranged to form a layer between a hydrophilic or microporous membrane and a textile layer where the textile layer may form an item of clothing. In such a case, the item will have first applied to the surface which provides the exterior surface of the garment when being worn, a layer of the protective material of the invention and second, a layer of a further protective material such as a fire retardant material. In order to secure the layers together the use of an adhesive may be necessary. If such an adhesive was applied as a continuous film it would need to be hydrophilic in character to ensure that transfer of water vapour through the laminate was not interrupted. Conveniently however, the adhesive may be applied as a discontinuous layer, as for example in a diamond-shaped pattern to allow water transfer through the gaps in the pattern.

Conveniently, there may be applied to the inner surface of an item of clothing such as a protective suit, one or more layers that include a carbon or other adsorbent material so as to provide a means of absorbing chemical warfare or other agents that have passed into the suit through closures (ankles, wrists etc).

The laminate of this invention is preferably substantially permeable to water vapour, preferably having a water vapour permeability of at least 400 g/m²/day, more preferably at least 600 g/m²/day and most preferably at least 800 g/m²/day. At the same time, the layer of the composition in such a laminate provides an unexpectedly high resistance to harmful agents such as chemical warfare agents while the other layer or layers in the laminate can be selected to provide other useful properties such as physical strength or heat resistance (while at the same time being water vapour permeable).

In such laminates the layer of the composition may suitably have a thickness of between 1 and 1000 μm but a thicker layer may be useful in some situations. The required thickness will depend on the precise mode of use of the laminate. For application on to a fabric substrate, it has been found that it may be desirable for the layer thickness to be between 10 and 100 μm, preferably between 20 and 60 μm. This gives good protection without making the fabric too heavy or stiff. For other applications it may be desirable for the layer to have a thickness of at least 20 μm.

The present invention will now be described by way of example only with reference to the following Examples.

### EXAMPLE 1

### Manufacture of Polymer Compositions Comprising Poly(Diallyl-Dimethylammonium Chloride) and Polyvinyl Alcohol (PVOH) (Cast Film)

PVOH (99+% hydrolysed, Mw ca 121,000; 10.0 g) and cold distilled water (50 cm³) were placed in a vessel and heated to 90-95° C. with stirring until the PVOH was dissolved. Heating was continued for a further 10 minutes, then a 20% w/w solution of p(DADMAC) (Mw ca 100,000-200,00; 50 cm³) was added and the temperature brought back to 90-95° C.

The solution was maintained at this temperature for 10 minutes. The polymer solution was then removed from the heat and stirring ceased so that bubbles could rise out of the solution. The still hot polymer solution was then cast by pouring onto a glass plate and drawing a blade over at a height of 0.5 mm above the glass. The polymer solution was then covered to minimise water evaporation and returned to the hotplate until a second cast was made ca 1 hour later (replacing evaporated water as necessary). This second cast was made at a blade height of 1.0 mm above the glass plate. The cast film was then allowed to ‘dry’ overnight under ambient conditions before being peeled from the glass plate.

The p(DADMAC) was supplied by Sigma-Aldrich Co. (cat. No. 409014).

### EXAMPLE 2

### Manufacture of Polymer Composition Layer on a Substrate

A composition of PVOH (Celvol 203 polyvinyl alcohol from Celanese Chemicals (87-89% hydrolysed, Mw 13,000-23,000) with p(DADMAC) (same material as in Example 1) was cast onto a microporous polyurethane membrane (30 μm thickness) at a thickness of ca 100 μm. After drying the composition layer was between 20 and 30 μm thick.

### EXAMPLE 3

### Measurement of Agent Penetration Through Composition Layer

A sheet of the cast composition of Example 1 was mounted in a test cell and a glass dish containing 5×2 microlitre drops of HD (sulphur mustard) and GD (soman) was placed over the sample. The vapour penetrating the test sample was subsequently analysed using gas-liquid chromatography. Less than 1 microgram HD and GD vapour penetrated in 24 hours (i.e. less than the limit of detection) for three separate samples.

### EXAMPLE 4

### Measurement of Water Vapour Permeability

The water vapour permeability index (WVPI) of cast film samples manufactured as in Example 1 was measured on a SDL International M261 water vapour permeability tester using a method, summarised below, based on that given in BS3424-34:1992.

Distilled water (46 cm³) was placed in a circular aluminium dish having an internal diameter of 83 mm and an internal depth of 18.5 mm such that there was an air gap of 10 mm between the surface of the water and the rim of the dish. Several notches 6 mm deep in the rim of the dish are used for receiving a wire support which covers the top of the dish and provides support for film samples to prevent them from sagging. Evo-stik multi-purpose clear adhesive was applied to the top of the rim around the entire circumference of the dish and a portion of each sample to be tested was cut to size and placed onto the adhesive so that the entire aperture of the dish was covered. A cover ring of the same internal and external diameter as the dish was then placed over the rim of the dish and, whilst pushing downwards firmly, adhesive tape applied to the outside of it and to the dish to hold it in place. Dishes covered with a standard reference material (a precision, high tenacity polyester woven monofilament mesh with a mesh aperture of 18 μm, yarn diameter of 32 μm, 191.6 threads cm⁻¹ and an open area of ca 12.5%, available as M261A1 from SDL International) were prepared similarly. The samples were tested in duplicate with duplicate controls.

The dishes were placed on a turntable located in an environmentally controlled chamber at 65% RH and 22° C. and allowed to equilibrate whilst rotating for at least one hour. The dishes were then weighed, placed back on the turntable and weighed again after 24 hours (other weighings were taken within the 24 hour period). The WVP (in g m⁻² day⁻¹) for each sample and standard is calculated using Equation 1:

$$WVP = \frac{24 M}{At} \qquad ( 1 )$$

where M (g) is mass loss over time t, the time between measurements (typically 24 hours), and A is the area of exposed test specimen (0.0054113 m² using the equipment described above).

The WVP of the reference specimens were averaged and used to calculate the water vapour permeability index (WVPI) of the samples according to Equation 2:

$$WVPI = 100 ( \frac{{WVP}_{( sample )}}{{WVP}_{( reference )}} ) \qquad ( 2 )$$

The WVPI of the duplicate samples were then averaged and used to compare samples tested at different times.

The PVOH-p(DADMAC) film produced and measured as described above had an average WVPI of 96% and its WVP was 804 g/m²/day.

By way of comparison, the WVPI of a film prepared the same way and using the same PVOH, but without the p(DADMAC), was measured at 31% (260 g/m²/day) (corrected figure to allow for these tests being carried out at a different value of RH).

The agent penetrations for this comparative material were 4 mg of H vapour and 15 mg GD vapour measured on the same basis as in Example 3 over a period of 24 hrs.

1. A water vapour permeable protective material having a low permeability to harmful and/or noxious agents which comprises a composition comprising a mixture of a quaternary amine and polyvinyl alcohol.

2. A water vapour permeable protective material according to claim 1 wherein the quaternary amine is a polymeric quaternary amine.

3. A water vapour permeable protective material according to claim 2 wherein the quaternary amine is selected from poly(diallyldimethyl-ammonium chloride) [p(DADMAC)], a copolymer with acrylamide-poly(acrylamide-codiallyldimethylammonium chloride), poly(acrylamide 2-methacryloxyethyltrimethylammonium bromide), poly[bis(2-chloroethyl) ether-alt-1,3bis[3-(dimethylamino)propyl]urea], quaternised, poly(diallyldiethylammonium bromide) and poly(4-vinylpyridine), methyl chloride quaternised.

4. A water vapour permeable protective material according to claim 3 wherein the quaternary amine is poly(diallyldimethyl-ammonium chloride) [p(DADMAC)].

5. A water vapour permeable protective material according to claim 1 wherein the quaternary amine is selected from tetrabutylammonium chloride, tetrabutylammonium bromide, tetrabutylammonium iodide, tetrabutylammonium sulphate and tetraethylammonium chloride.

6. A water vapour permeable protective material according to claim 1 wherein the composition is in the form of a layer.

7. A water vapour permeable protective material according to claim 6 wherein the layer has a thickness of between 1 and 1000 μm.

8. A water vapour permeable protective material according to claim 7 wherein the layer has a thickness of between 20 and 60 μm.

9. A water vapour permeable protective material according to claim 1 wherein the composition further comprises a cross-linking agent.

10. A water vapour permeable protective material according to wherein the total mass of quaternary amine and polyvinyl alcohol is between 10% and 95% and preferably between 60% and 95% of the mass of the polymer composition.

11. A water vapour permeable protective material according to claim 10 wherein the balance of the composition comprises water.

12. A water vapour permeable protective material according to claim 10 wherein the balance of the composition comprises a non-aqueous solvent.

13. A water vapour permeable protective material according to claim 10 wherein the balance of the composition comprises both water and a non-aqueous solvent.

14. A water vapour permeable protective material according to claim 1 wherein the layer is in the form of a sacrificial coating.

15. A water vapour permeable protective material according to claim 1 which exhibits a permeability to water vapour of at least 400 g/m²/day.

16. A water vapour permeable protective material according to claim 15 which exhibits a permeability to water vapour of at least 600 g/m²/day.

17. A water vapour permeable protective material according to claim 15 which exhibits a permeability to water vapour of at least 800 g/m²/day.

18. A fabric material coated with a layer of the water vapour permeable protective material according to claim 1 to provide substantially water permeable protection against harmful and/or noxious agents.

19. A coated fabric as claimed in claim 18 which comprises an item of protective clothing.

20. A coated fabric as claimed in claim 18 wherein the layer of the water vapour permeable protective material has a thickness of from 10 and 100 μm, preferably between 20 and 60 μm.

21. A laminate for providing protection against harmful and/or noxious agents and comprising at least one layer of a composition comprising a mixture of a quaternary amine and polyvinyl alcohol wherein the laminate has a low permeability to harmful and/or noxious agents and is substantially permeable to water vapour.

22. A laminate according to claim 21 comprising at least one layer of said composition in combination with one or more layers of a microporous or hydrophilic material.

23. A laminate as claimed in claim 22 wherein the layer of said composition is interposed between at least two layers of a microporous or hydrophilic material.

24. A laminate as claimed in claim 22 wherein one of the layers of microporous or hydrophilic material comprises a fabric.

25. A laminate as claimed in claim 24 wherein the fabric comprises an item of clothing.

26. A laminate as claimed in claim 24 wherein the layer of said composition is interposed between the fabric material and one or more further layers of a microporous or hydrophilic material.

27. A laminate as claimed in claim 21 which exhibits a permeability to water vapour of at least 400 g/m²/day, more preferably of at least 600 g/m²/day.

28. A laminate as claimed in claim 27 which exhibits a permeability to water vapour of at least 800 g/m²/day.

29. A laminate as claimed in claim 21 wherein the layer of the composition has a thickness of from 1 and 1000 μm, preferably between 10 and 100 μm.

30. An item of protective clothing comprising a laminate according to any claim 21.

31. A method of imparting to an article substantially water permeable protection against harmful and/or noxious agents, the method comprising applying a coating of a composition comprising a mixture of a quaternary amine and polyvinyl alcohol to a surface of the article to be protected.

32. A method as claimed in claim 27 wherein the coating is applied at a thickness of between 1 and 1000 μm, preferably between 10 and 100 μm.

33. A method as claimed in claim 31 wherein the polymer composition is cast directly onto the surface to be protected.

34. A method as claimed in claim 31 wherein the polymer composition is cast in the form of a film which is then applied to the surface to be protected.

35. (canceled)

36. A method for forming a chemically- or biologically-resistant material or product wherein a water vapour permeable protective material as claimed in claim 1 is treated by a shape-forming process.

37. A method as claimed in claim 36 wherein the shape-forming process is a moulding process, preferably injection moulding.

38. A method as claimed in claim 36 wherein the shape-forming process is an extrusion process.

39. A chemically- or biologically-resistant material or product obtainable from a method as claimed in claim 36.

40. A composition comprising a mixture of a quaternary amine and polyvinyl alcohol in the form of a film for application for the substantially water permeable protection of an object or surface against harmful and/or noxious agents.

41. Use of a composition comprising a mixture of a quaternary amine and polyvinyl alcohol for substantially water permeable protection against chemical and/or biological warfare agents.
